(19) United States
(12) Patent Application Publication
(10) Pub. No.: US 2018/0010662 A1
(43) Pub. Date: Jan. 11, 2018

(54) SPRING END CAP WITH IMPROVED RETENTION

(71) Applicant: Schaeffler Technologies AG & Co. KG, Herzogenaurach (DE)

(72) Inventors: Felipe de Lima Zocca, Wooster, OH (US); Phani Krishna Kalapala, Wooster, OH (US); Scott Strong, Wooster, OH (US)

(73) Assignee: Schaeffler Technologies AG & Co. KG, Herzogenaurach (DE)

(21) Appl. No.: 15/643,896

(22) Filed: Jul. 7, 2017

Related U.S. Application Data
(60) Provisional application No. 62/360,779, filed on Jul. 11, 2016.

(51) Int. Cl. F16F 1/12; F16F 1/06

(52) U.S. Cl. CPC F16F 1/125; F16F 1/06

(57) ABSTRACT

A spring end cap includes a central axis, first and second parallel planar ends, and first and second circumferential surfaces. The planar ends are orthogonal to the central axis. An outer diameter of the first planar end is larger than an outer diameter of the second planar end. The first and second circumferential surfaces are disposed about the axis and between the planar ends. The first circumferential surface is disposed between the first planar end and the second circumferential surface. The first circumferential surface has a diameter smaller than a diameter of the second circumferential surface.

### FIELD

The invention relates generally to a spring end cap, and more specifically to a spring end cap with improved retention.

### BACKGROUND

Springs with end caps are known. Examples are shown in U.S. Pat. Nos. 5,772,515 and 6,041,905.

### BRIEF SUMMARY

Example aspects broadly comprise a spring end cap including a central axis, first and second parallel planar ends, and first and second circumferential surfaces. The planar ends are orthogonal to the central axis. An outer diameter of the first planar end is larger than an outer diameter of the second planar end. The first and second circumferential surfaces are disposed about the axis and between the planar ends. The first circumferential surface is disposed between the first planar end and the second circumferential surface. The first circumferential surface has a diameter smaller than a diameter of the second circumferential surface.

In an example embodiment, the diameter of the first circumferential surface is larger than the outer diameter of the second planar end. In an example embodiment, the diameter of the second circumferential surface is larger than the outer diameter of the second planar end. In an example embodiment, the spring end cap has a first conical surface disposed about the axis and extending between the second circumferential surface and the second planar end. In an example embodiment, the spring end cap has a second conical surface disposed about the axis and extending between the first and second circumferential surfaces.

In some example embodiments, the spring end cap has a third planar surface. The third planar surface is parallel to the first planar end, has an outer diameter equal to the outer diameter of the first planar end, and is disposed axially between the first planar end and the first circumferential surface. In an example embodiment, the spring end cap has a third circumferential surface extending between the first planar end and the third planar surface. In an example embodiment, the spring end cap has an undercut portion. The undercut portion has a third conical surface extending from the third planar surface towards the first planar end, a fourth planar surface parallel to the first planar end and extending from the third conical surface, and a partial toroidal surface connecting the fourth planar surface with the first circumferential surface.

Other example embodiments broadly comprise a spring assembly including the spring end cap and a coil spring fixedly secured to the spring end cap. In some example embodiments, in an unassembled state, the coil spring includes a first end coil with a first inner diameter and a second coil with a second inner diameter, larger than the first inner diameter. In an example embodiment, the first inner diameter is less than the diameter of the first circumferential surface. In some example embodiments, the coil spring includes at least one dead coil and a plurality of active coils. All of the at least one dead coil is in contact with the spring end cap and all of the plurality of active coils are devoid of contact with the spring end cap. In an example embodiment, the coil spring includes at least one transition coil extending from the at least one dead coil to the plurality of active coils. In an example embodiment, the coil spring is arcuately shaped.

### BRIEF DESCRIPTION OF THE DRAWINGS

The nature and mode of operation of the present invention will now be more fully described in the following detailed description taken with the accompanying drawing figures, in which:

FIG. 1 is a cross-section view of a spring end cap with improved retention according to an example aspect;

FIG. 2 is detail cross-section view of the spring end cap of FIG. 1 assembled with a spring showing interference;

FIG. 3 is a cross-section view of the spring assembly of FIG. 2.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

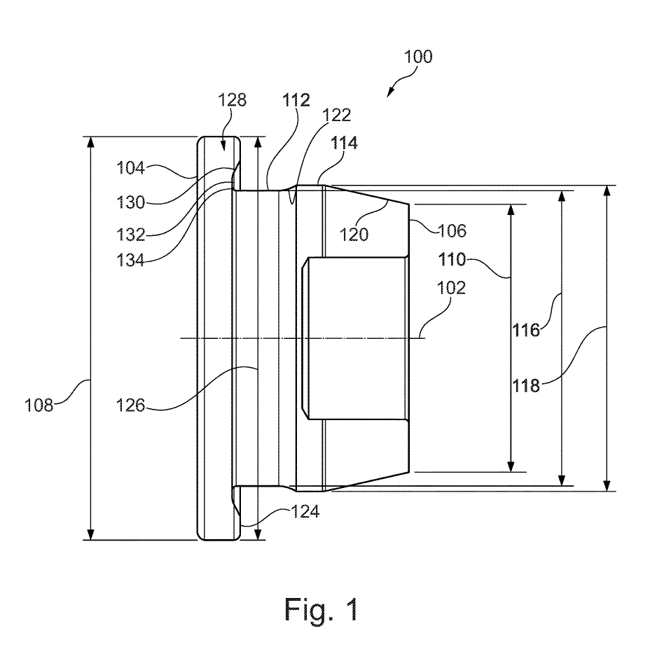

The following description is made with reference to FIG. 1. FIG. 1 is a cross-section view of spring end cap 100 with improved retention according to an example aspect. Spring end cap 100 includes a central axis 102 and parallel planar ends 104 and 106 orthogonal to the central axis. Outer diameter 108 of planar end 104 is larger than outer diameter 110 of planar end 106. Spring end cap 100 also includes circumferential surfaces 112 and 114 disposed about axis 102 and between planar ends 104 and 106. Circumferential surface 112 is disposed between planar end 104 and circumferential surface 114. Surface 112 has diameter 116 smaller than diameter 118 of circumferential surface 114. Diameter 116 of circumferential surface 112 is larger than diameter 110 of planar end 106. Diameter 118 of circumferential surface 114 is larger than outer diameter 110 of planar end 106.

End cap 100 also includes conical surface 120 disposed about axis 102 and extending between circumferential surface 114 and planar end 106. End cap 100 also includes conical surface 122 disposed about axis 102 and extending between circumferential surfaces 112 and 114. End cap 100 has planar surface 124. Surface 124 is parallel to planer end 104. Surface 124 has outer diameter 126 equal to outer diameter 108 of planar end 104. Surface 124 is disposed axially between the planar end 104 and circumferential surface 112. Spring end cap 100 includes circumferential surface 128 extending between planar end 104 and planar surface 124.

End cap 100 includes undercut portion 128. Portion 128 includes conical surface 130 extending from planar surface 124 towards planar end 104. Undercut portion 128 also includes planar surface 132 parallel to planar end 104 and extending from conical surface 130. Undercut portion also includes partial toroidal surface 134 connecting planar surface 132 with circumferential surface 112.

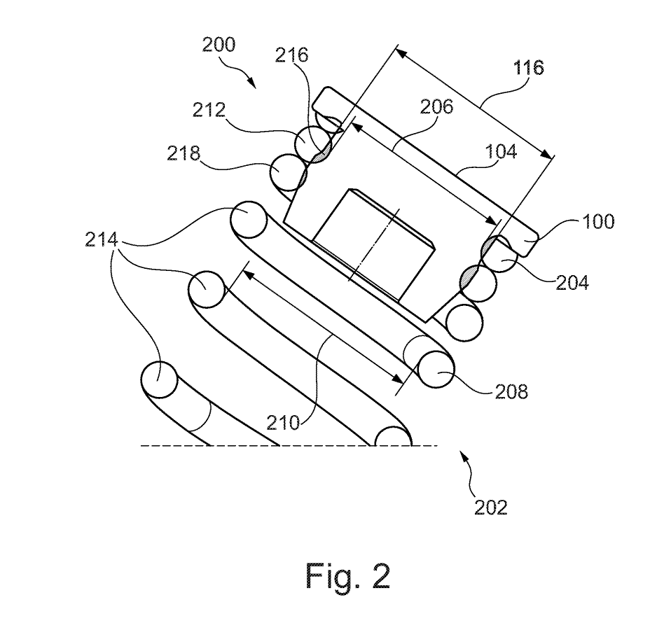

The following description is made with reference to FIGS. 1-2. FIG. 2 is detail cross-section view of spring end cap 100 of FIG. 1 assembled with spring 202 showing interference. Spring assembly 200 includes spring end cap 100 and coil spring 202 fixedly secured to spring end cap 100. In an unassembled state (or as shown with interference in FIG. 2), coil spring 202 includes end coil 204 with inner diameter 206 and coil 208 with inner diameter 210. Inner diameter 210 is larger than inner diameter 206. Inner diameter 206 is less than diameter 116 of circumferential surface 112. Coil spring 202 includes dead coil 212 and active coils 214. By dead coil, we mean that adjacent spring coils rest upon one another such that there is no compression in that part of the spring. Dead coil 212 is in contact with spring end cap 100 (as indicated by interference region 216). Active coils 214 are devoid of contact with spring end cap 100. Spring 202 includes transition coil 218 extending from dead coil 212 to active coils 214.

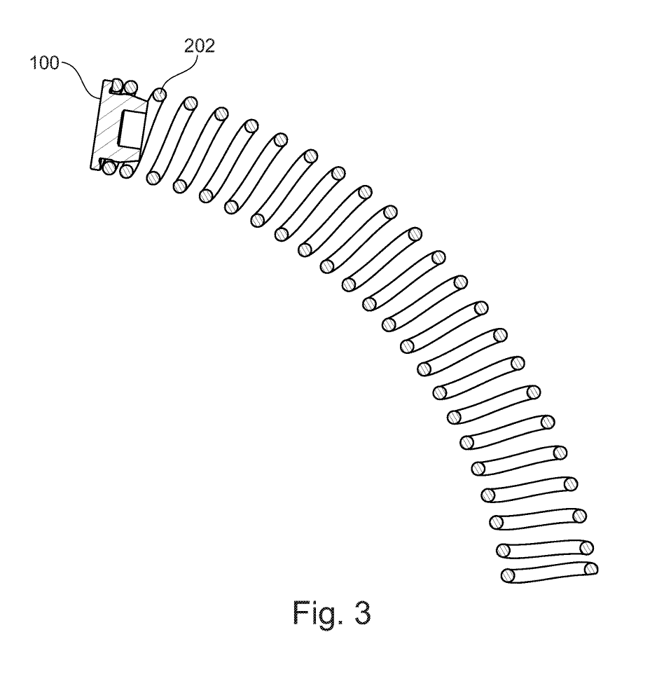

The following description is made with reference to FIGS. 1-3. FIG. 3 is a cross-section view of spring assembly 200 of FIG. 2. Coil spring 202 is arcuately shaped. In other applications (not shown), spring 202 may be a straight spring.

The two steps of interference between the spring and end cap (i.e., at surfaces 112 and 114) improve retention of endcap 100 in spring 202. That is, the groove formed at surface 112 retains the endcap on the spring by retaining in two directions. For example, the spring is retained by the compression of coil 212 on surface 112 and the need to expand coil 212 over larger diameter surface 114 to remove the spring from the endcap. The groove works in conjunction with a press-fit of transition coil 218 at surfaces 114 and 120. Axial lengths of surfaces 112 and 114 are selected based on wire diameter and number of dead coils. Active coils 214 are designed with diameters large enough to avoid contact with the endcap for improved durability, but the transition coil(s) must avoid aggressive transitions between diameters due to stress concerns but allow larger active coils and maximized interference with the end cap.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What we claim is:

1. A spring end cap comprising:
a central axis;
first and second parallel planar ends orthogonal to the central axis, an outer diameter of the first planar end being larger than an outer diameter of the second planar end; and,
first and second circumferential surfaces disposed about the axis and between the planar ends, the first circumferential surface disposed between the first planar end and the second circumferential surface and having a diameter smaller than a diameter of the second circumferential surface.

2. The spring end cap of claim 1 wherein the diameter of the first circumferential surface is larger than the outer diameter of the second planar end.

3. The spring end cap of claim 1 wherein the diameter of the second circumferential surface is larger than the outer diameter of the second planar end.

4. The spring end cap of claim 1 further comprising a first conical surface disposed about the axis and extending between the second circumferential surface and the second planar end.

5. The spring end cap of claim 1 further comprising a second conical surface disposed about the axis and extending between the first and second circumferential surfaces.

6. The spring end cap of claim 1 further comprising a third planar surface:
parallel to the first planar end;
having an outer diameter equal to the outer diameter of the first planar end; and,
disposed axially between the first planar end and the first circumferential surface.

7. The spring end cap of claim 6 further comprising a third circumferential surface extending between the first planar end and the third planar surface.

8. The spring end cap of claim 6 further comprising an undercut portion including:
a third conical surface extending from the third planar surface towards the first planar end;
a fourth planar surface parallel to the first planar end and extending from the third conical surface; and,
a partial toroidal surface connecting the fourth planar surface with the first circumferential surface.

9. A spring assembly comprising:
the spring end cap of claim 1; and,
a coil spring fixedly secured to the spring end cap.

10. The spring assembly of claim 9 wherein, in an unassembled state, the coil spring includes a first end coil with a first inner diameter and a second coil with a second inner diameter, larger than the first inner diameter.

11. The spring assembly of claim 10 wherein the first inner diameter is less than the diameter of the first circumferential surface.

12. The spring assembly of claim 9 wherein the coil spring includes at least one dead coil and a plurality of active coils, wherein all of the at least one dead coil is in contact with the spring end cap and all of the plurality of active coils are devoid of contact with the spring end cap.

13. The spring assembly of claim 12 where the coil spring includes at least one transition coil extending from the at least one dead coil to the plurality of active coils.

14. The spring assembly of claim 9 wherein the coil spring is arcuately shaped.
